(19) United States
(12) Patent Application Publication
(10) Pub. No.: US 2006/0077356 A1
(43) Pub. Date: Apr. 13, 2006

(54) Transportable projecting device

(76) Inventor: Peter Merczak, Dusseldorf (DE)

Correspondence Address: FRIEDRICH KUEFFNER, 317 MADISON AVENUE, SUITE 910, NEW YORK, NY, 10017, US

(21) Appl. No.: 11/237,623

(22) Filed: Sep. 27, 2005

(30) Foreign Application Priority Data
Sep. 27, 2004 (DE) 20 2004 015 139.1
Oct. 5, 2004 (DE) 20 2004 015 307.6

(51) Int. Cl. G03B 21/56

(52) U.S. Cl. 353/79; 359/443

(57) ABSTRACT

A transportable projecting device, particularly for home cinemas, including a fabric or film-like, foldable projecting screen with a rectangular base and with fastening points for mounting arranged in the corner areas, as well as a stand with a bottom base and an upper support. The support is designed like a case and has at least four seats arranged in one plane, each for a supporting member which is designed like a spring rod, and wherein free ends of the spring rod-like supporting members are connectable with the fastening points of the projecting screen.

### BACKGROUND OF THE INVENTION

1. Field of the Invention

The present invention relates to a transportable projecting device, in particular for home cinemas, with a fabric or film-like, folding projecting screen with a rectangular base and with fastening points serving for mounting and particularly arranged in the corner area as well as a stand with a bottom base and an upper support.

2. Description of the Related Art

Fixed projecting devices made of board or slabs with a rectangular base are known as projecting screens, which are either mounted via a support on a stand or directly on a wall. The deployment of such projecting devices however is declining since these are not transportable or only to a limited degree. Increasingly fabric or film-like projecting screens are therefore used. These projecting screens are usually rolled up on a roll located inside a case and are unrolled for use upwards against the force of a pre-stressed spring thereof and suspended via a support on a stand. The projecting screen is tightened and stretched by the weight of the roll and the case. For nonutilization the projecting screen is again rolled into the case. In this state, the projecting device is then transportable either in a pivotable position or separated from the stand. It is considered disadvantageous with such projecting devices that they are bulky and difficult to transport due to the case which of course exhibits at least the length of the width of the projecting screen.

### SUMMARY OF THE INVENTION

It is the object of the present invention to provide a projecting device, particularly for home cinemas with a fabric or film-like projecting screen which is relatively small and light and can furthermore be handled in an easy manner.

This object is met for a projecting device of the above-described type in that the support is constructed like a case and exhibits at least four seats arranged in one plane, each for one supporting member which is designed like a spring rod, and that the free ends of the spring rod-like supporting members are connectable with the fastening points of the projecting screen.

A projecting screen constructed in such a way can either be taken apart or folded together, has a relatively light weight, and due to its small size is light and easy to handle and thus to transport.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 is an elevational view of the back side of a projecting screen according to the invention;

FIG. 2 is a view of an embodiment of a support deviating from FIG. 1;

FIG. 3 is an elevational view of the back side of the projecting screen according to the invention; and

FIG. 4 is a view of a further embodiment of a projecting screen.

### DETAILED DESCRIPTION OF THE INVENTION

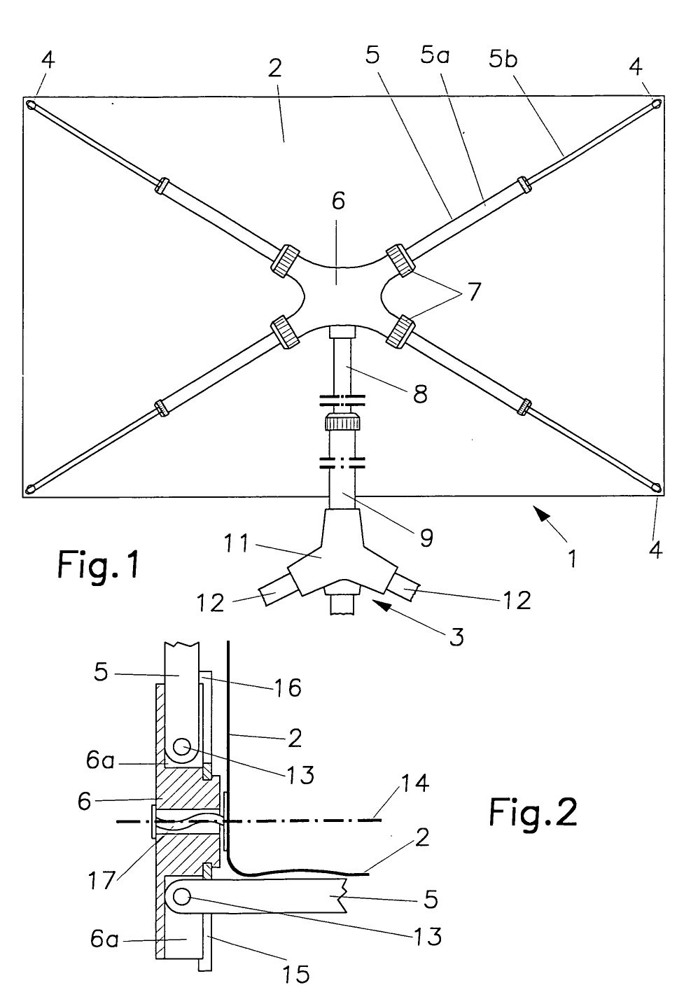

A transportable projecting screen 1 is shown in FIG. 1 of the drawing, in which its individual pieces, which is expressly pointed out for the purpose of better clarity of the drawing, are not necessarily drawn to scale. This projecting screen 1 consists of a fabric or film-like projecting screen 2, shown mounted, and a stand 3, shown only partially.

The projecting screen 2 has a rectangular base and is advantageously provided with a coating known in the art on its front side. In this embodiment, there is a fastening point each only at the corners designed as an eyelet 4 which is known in the art. A hook, not shown in the drawing, which is attached to the end of a supporting member 5 respectively, engages with each of these eyelets 4. All four supporting members 5 are designed like a spring rod and advantageously comprise two parts 5a and 5b which are made of plastic or light metal for the purpose of weight economization and have a hollow cross-section for further economizing weight. The cross-section thereby can be circular, oval or rectangular. The part 5b of each supporting member 5 exhibits a predetermined smaller cross-section than the part 5a which is chosen such that the part 5b can be axially shifted and taken in by part 5a of the supporting member 5. The part 5b thereby supports itself via a spring, not shown, in the part 5a, so that the part 5b of each supporting member 5 is always pressed axially outward by means of the force of this spring. All four parts 5b of the supporting members 5 which are pressed radially outward thereby effect that the fabric or film-like projecting screen 2 is always kept under tension. In order to make this tension possible, all parts 5a of the supporting members 5—as revealed in the drawing—are inserted cross-like into a case-like support 6. The case-like support 6 is also made of plastic or light metal for the purpose of weight economization. The case-like support 6 can either be designed as one piece or made of two half-shells which are connected together.

The case-like support 6 has four insertion openings arranged cross-like for taking in the parts 5a of the supporting members 5. The parts 5a of the supporting members 5 are advantageously secured in these insertion openings by means of clamping. The clamping can thereby be effected by means of a clamping ring 7 or by means of a screw.

The case-like support 6 further has a receiving opening for the perpendicular supporting tube 8 of the stand 3. This stand 3 is designed to be height-adjustable. For this purpose, the supporting tube 8 already mentioned is movably and fixedly guided in a further supporting tube 9. Fixing can be effected for example by means of a clamping ring 10 or a screw. The supporting tubes 8, 9 are also advantageously made of plastic or light metal and can have a circular, oval or rectangular cross-section. The supporting tube 9 is pluggable and preferably clamping when taken in by a base part 11 which is also made of plastic or light metal. In addition to the receiving opening for the supporting tube 9, the base part 11 has three further receiving openings into which a splay-foot 12—only hinted at—each can be clampingly inserted. The stand 3 hereby obtains good stability.

Based on the described design, the projecting device 1 comprising the fabric or film-like projecting screen 2 and the stand 3 can be easily put together within the shortest amount of time and can also be taken apart again. The projecting device 1 in its disassembled state, in which the fabric or film-like projecting screen 2 is folded or rolled up, can be stored in the smallest amount of space, has a light weight and therefore can be transported well. In an assembled state, the spring rod-like supporting members 5 comprising parts 5a and 5b provide the necessary taut condition of the projecting screen 2. A special, frame-like reinforcement of the projecting screen 2 is normally not necessary.

Another design of the support 6 is shown in FIG. 2 of the drawing which can also be fastened on the supporting tube 8 of the stand 3—by means of a plugging action. This support 6 exhibits recesses 6a in which the supporting members 5 comprising parts 5a and 5b can be attached over the axle 13 and thus are pivotably held at the support 6. The projecting screen 2 is also provided here with eyelets in its corners, into which the already mentioned hooks of parts 5b of the supporting members 5 can be inserted. As shown alternately above and below the center line of FIG. 2—the supporting members 5 can take a position over the axles 13 which is either in the plane of the support 6 (FIG. 2, top) or a right-angled position thereto (FIG. 2, bottom). In the position of the supporting members 5 according to FIG. 2, top, the fabric or film-like projecting screen is taut for a faultless projection, while the fabric or film-like projecting screen 2 in the position of the supporting members 5 according to FIG. 2, bottom, is folded together like an umbrella. In this folded position of the supporting members 5 and of the projecting screen 2, these take up a small space and are easy to transport. In order to secure the supporting members 5 in the taut position of the projecting screen 2 according to FIG. 2, top, a locking washer 15 is provided on the support 6 which after a turn of, for example, 45° respectively, abuts a projection 16 on the part 5a of the supporting member 5. When turning accordingly in the other direction, the supporting members 5 are again released for folding the projecting screen 2.

In order to prevent that the projecting screen 2 according to the embodiment of FIG. 2 completely hangs out between the supporting members 5 when in a folded state, an elastic locking plug 16 is provided on the support 6 with which the protecting screen 2 is joined for example by means of gluing.

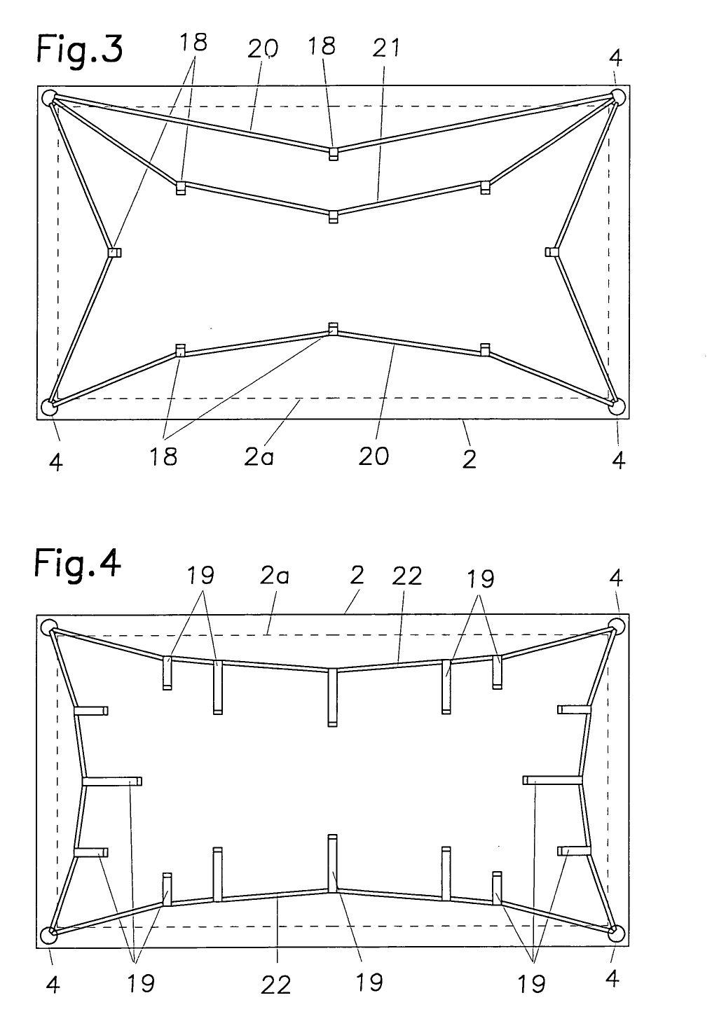

According to the embodiments of FIGS. 3 and 4 the formation of creases of the projecting screen 2 is prevented and thus a smooth surface of the projection area 2a, in that several intermediate points 19, 20 are provided on the back side of the projecting screen 2, which are designed as loops in the drawn embodiments of FIGS. 1 and 2 and are fastened with one end to the back side of the projecting screen 2, for example, by means of gluing. These intermediate points 18, 19 are arranged as evenly dispersed as possible across the back side of the projecting screen 2 and are located primarily at places where there might be a danger of creases forming in the projecting screen 2. According to FIG. 3 of the drawing, a total of nine such loop-like intermediate points 18 are provided on the back side of the projecting screen 2 which are made of a ribbon-like, non-elastic material that can be connected well with the back side of the projecting screen 2. In this embodiment two connecting members 20, 21 designed as ropes are pulled through these loop-like intermediate points 18, which—contrary to the loop-like intermediate points 18—are made of an elastic material. Rubber, for example, can be used as an elastic material. It is possible to design only one area of the connecting members 20, 21 which is comprised of ropes in an elastic way, wherein there is the possibility to form the elastic parts of the connecting members 20, 21 as coil springs. Each rope-like connecting member 20, 21 is however always pulled through different loop-like intermediate points 18, i.e., none of both connecting members 20, 21 projects through the same intermediate points 18. In doing so, the rope-like connecting member 20 can be formed of one piece. In such a case, both ends of the connecting member 20 are suspended only in one eyelet 4 under a preload and pulled through the other three eyelets 4. It is however also possible and advantageous to form the elastic connecting member 20 out of four ropes, wherein each rope—also under a preload—is suspended in two neighboring eyelets 4.

The rope-like connecting member 21 is in principle only suspended in two neighboring eyelets 4 under preload. This design or arrangement of the loop-like intermediate points 18 and the use of elastic connecting members 20, 21 makes it possible that the projecting screen 2 is stretched in the area of its projection area 2a and thus that a formation of creases is excluded. If required, a spring rod can also be suspended as an elastic connecting member between two neighboring eyelets 4.

In the embodiment of FIG. 4 sixteen loop-like intermediate points 19 are fastened on the back side of the projecting screen 2. These loop-like intermediate points 19 however are made of a ribbon-like material which has elastic properties. In addition, the loop-like intermediate points 19 of FIG. 4 are substantially longer than the loop-like intermediate points 18 of FIG. 3. The loop-like intermediate points 19 can be of various lengths—as shown—and are also fastened like the loop-like intermediate points 18 of FIG. 2 with only one end on the back side of the projecting screen 2.

A connecting member 22 designed as a rope, but which does not exhibit elastic properties is also pulled through these loop-like intermediate points 19. The connecting member 22 can be, for example, made of one piece and suspended with both its ends in an eyelet 4. However, it also extends through the other three eyelets 4. Here it is also possible and advantageous to form the loop-like connecting member 22 out of four ropes, wherein each rope of the connecting member 22 is suspended with its ends in two neighboring eyelets 4 or fastened thereto. The rope-like connecting member 22 is suspended under tension in the eyelets 4. In doing so, the tension is not created directly by the connecting member 22, but by the elastic, loop-like intermediate points 19, which are tensioned when inserting or suspending the connecting member 22 in the eyelets 4.

By means of the connecting member 22 and the elastic, loop-like intermediate points 19 it is also ensured here that the projecting screen 2 is stretched by the rope-like connecting member 22 in the area of the projection area 2a of the projecting screen 2 and that the formation of creases is excluded. Here if necessary, the rope-like connecting member 22 can also be replaced by spring rods which are each suspended or mounted between two neighboring eyelets 4.

By modifying the described embodiments it is possible to provide the projecting screen 2 with more than four eyelets 4 at its corners and at its edges, for example with six, eight, ten or twelve eyelets 4. Then however, a corresponding number of openings must be provided on the support 6 for receiving a corresponding number of supporting members 5. This is for example appropriate if the projecting screen 2 exceeds a certain size. Also the arrangement of the loop-like intermediate points 18, 19 on the projecting screen 2 can be chosen differently. It is suggested in this regard that the number and the arrangement of the loop-like intermediate points 18, 19 on the projecting screen 2 is exclusively dependent on the size thereof and should always guarantee that the projecting screen 2 in the area of its projection area 2a is evenly stretched and does not form any creases. It is furthermore possible to obtain an elasticity of the loop-like intermediate points 19 in that the middle area thereof is formed by coil springs. Finally, the projecting screen 2 can also be fastened to the parts 5b of the supporting members 5 in a different way. For example, it is possible to design the ends of the parts 5b of the supporting members 5 elastically and thus bendable and then to suspend these under a preload in the eyelets 4 of the projecting screen 2.

I claim:

1. A transportable projecting device, particularly for home cinemas, comprising
a fabric or film-like, foldable projecting screen with a rectangular base and with fastening points provided for mounting and arranged in the corner areas,
a stand with a bottom base and an upper support, wherein the support is comprised of a case and has at least four seats arranged in one plane, each for a supporting member comprised of a spring rod, and wherein free ends of the spring rod-like supporting members are connectable with the fastening points of the projecting screen.

2. The device according to claim 1, wherein the spring rod-like supporting members are pluggably connected to the case-like support.

3. The device according to claim 1, wherein the spring rod-like supporting members are secured by clamping means in the case-like support.

4. The device according to claim 1, wherein the spring rod-like supporting members are hingedly connected to the case-like support.

5. The device according to claim 4, wherein the spring rod-like supporting members are lockable to the case-like support in a folded out position thereof.

6. The device according to claim 5, wherein the case-like support has a twistable locking washer for locking the spring rod-like supporting members.

7. The device according to at least one of claims 1 to 6, wherein the spring rod-like supporting members have a tubular cross-section.

8. The device according to claim 1, wherein the spring rod-like supporting members and/or the case-like support are of plastic or light metal.

9. The device according to claim 1, wherein edges of the fabric or film-like projecting screen are provided with eyelets and ends of the spring rod-like supporting members each have a hook.

10. The device according to claim 1, wherein the case-like support has an opening for pluggably receiving the stand.

11. The device according to claim 1, wherein the stand is adjustable in height.

12. The device according to claim 1, wherein at least one intermediate point for tautening of the projecting screen is mounted on the back side of the projecting screen always between two fastening points respectively, wherein the intermediate point is elastically connected via at least one connecting member with at least two fastening points of the projecting screen.

13. The device according to claim 12, wherein each intermediate point is elastic and the connecting member is a rope or a bar.

14. The device according to claim 12, wherein the connecting member is at least partially elastic.

15. The device according to claim 12, wherein the connecting member is comprised over at least a part of its length of an elastic rope, spring rod or a coil spring.

16. The device according to claim 12, wherein each intermediate point is comprised of a loop or an eyelet.
